(19) United States
(12) Patent Application Publication
(10) Pub. No.: US 2008/0179257 A1
(43) Pub. Date: Jul. 31, 2008

(54) Process for the Thermal Treatment of Pharmaceutical Waste Material

(76) Inventor: Stephen Clarke, Derby Junction (CA)

Correspondence Address: BOYLE FREDRICKSON S.C., 840 North Plankinton Avenue, MILWAUKEE, WI, 53203, US

(21) Appl. No.: 11/627,083

(22) Filed: Jan. 25, 2007

(51) Int. Cl. C02F 1/10; B01D 17/09

(52) U.S. Cl. 210/741; 210/775

(57) ABSTRACT

There is provided a process for the thermal treatment of waste materials, particularly pharmaceutical waste materials. The process comprises placing the waste material into a chamber and increasing the temperature inside the chamber in three stages. At a first stage, water in the material is desorbed as water vapor. At a second stage, organic ingredients in the material are desorbed and decomposed producing condensable organic vapor and non-condensable synthesis gas. And at a third stage, polymer-based components of the material are depolymerized and decomposed producing condensable hydrocarbon vapor. The non-condensable synthesis gas produced can be used as heating source for the process.

### FIELD OF THE INVENTION

The invention relates generally to processes for the thermal treatment of waste materials. In particular, the invention relates to a process for the thermal treatment of pharmaceutical waste materials, and subsequent recovery of oil.

### BACKGROUND OF THE INVENTION

Disposal of waste materials, in particular hazardous and non-hazardous pharmaceutical and personal consumer product waste, has generally been completed primarily through shredding and landfilling. While shredding removes potential product liability issues such as black market reselling of off-spec and expired products as well as unwanted public visibility of corporate identifiers, the desire to reduce the volume of waste to be landfilled has led to the development of alternative processes such as recycling, composting and incineration. These processes have some benefits but also present significant disadvantages. For example, not all components of the waste stream present sufficient economic value to justify a recycling program. Also, not all components of the waste stream are suitable for compost production. And incineration is widely known as requiring high levels of energy and sophisticated equipment as well as producing airborne emissions; moreover incineration does not allow for the recovery of hydrocarbons. On the other hand, it is desirable to recover at least some valuable materials from the waste in order to reduce the environmental pollutants that may result from their decomposition.

Numerous waste materials comprise medicinal ingredients that are classified as regulated compounds, and require total destruction. Various processes allowing for the destruction of these compounds, including thermal treatment, are known in the art. For example, U.S. 2005/0218037 discloses a process for thermal treatment of multiphase residues. The process uses a three-stage temperature gradient, wherein the temperature increases from about 80 to 250° C. Each stage is carried out within a separate zone of the reactor, and the material to be treated is circulated from one zone to the other. The process takes place under inert atmosphere, and yields oil, water, hydrocarbons as well as solid residue. U.S. Pat. No. 6,840,712 discloses a similar process with the temperature increasing from about 316 to 649° C.

U.S. Pat. No. 4,013,516 and Canadian patents 2,543,320; 2,515,431; 2,313,801; 2,251,004; and U.S. Pat. No. 2,423,714 also disclose similar thermal treatment processes, at various temperature ranges.

There remains a need for simple, environmentally friendly and cost efficient thermal treatment processes of waste materials.

### SUMMARY OF THE INVENTION

The inventors have developed a process that combines desorption, depolymerization and pyrolysis for the treatment of waste materials, particularly pharmaceutical waste materials. The material to be treated is placed in a reaction chamber and subjected to a three-stage gradient temperature, without any need to circulate the material. The process ensures residence time at such temperatures as to thermally destroy the medicinal ingredients. The process also allows for a continuous recovery of oil, water as well as non-condensable synthesis gas that can be used as heating source for the process. The process yields a solid residue of significantly reduced size that is suitable for safe landfilling.

The invention thus provides according to an aspect, for a process for the thermal treatment of waste material in a chamber. The process comprises the steps of: a) heating the chamber at a first temperature to cause water in the material to desorb as water vapor; b) heating the chamber at a second temperature higher than the first temperature to cause organic ingredients in the material to desorb and decompose producing condensable organic vapor and non-condensable synthesis gas; and c) heating the chamber to a third temperature higher than the second temperature to cause polymer-based components of the material to depolymerize and decompose producing condensable hydrocarbon vapor.

The water vapor, the condensable organic vapor and the condensable hydrocarbon vapor produced in the process can be continuously recovered and condensed as an oil-water mixture; and the non-condensable synthesis gas can be continuously recovered as fuel for combustion or for heating.

In a preferred embodiment of the process, the first temperature can be about 100° C., the second temperature can be about 250 to 350° C. and the third temperature can be about 350 to 500° C.

The process according to the invention can be carried out on various types of waste materials including but not limited to waste material derived from industrial wastes such as pharmaceutical, petrochemical, packaging, plastics manufacturing, mining, petroleum refining, paint and ink manufacturing, sludges as well as mixtures thereof. The waste material can also be a cellulose material, a polyolefin-based resin, used tires, contaminated soils or mixtures thereof.

In a preferred embodiment of the invention, the waste material is a pharmaceutical waste material.

The waste material may be subjected to a size reduction step prior to being placed into the chamber. The size reduction step may comprise shredding the waste material to obtain particles having a size of less than about 30 mm.

In a preferred embodiment, the non-condensable synthesis gas is used as heat source for the process. Also, the process can further comprise a step of separating oil and water from the oil-water mixture.

During the process, heat can be transmitted to the chamber through its external surface. Optionally, the heat may stem from a heating source which can be hot oil, electrical resistance heating, induction heating or a flue of the non-condensable synthesis gas. The material in the chamber may be subjected to continuous agitation. The pressure inside the chamber may be negative, and the atmosphere substantially free of oxygen or inert. Optionally, an inert gas such as nitrogen or argon can be introduced into the chamber.

The volume of the treated waste material recovered after the process may be about 90% reduced.

According to another aspect, the invention provides for a process for the thermal treatment of waste material in a chamber, the process comprising the steps of: a) heating the chamber at a first temperature to cause water in the material to desorb as water vapor; b) heating the chamber at a second temperature higher than the first temperature to cause organic ingredients in the material to desorb and decompose producing condensable organic vapor and non-condensable synthesis gas; c) heating the chamber to a third temperature higher than the second temperature to cause polymer-based components of the material to depolymerize and decompose producing condensable hydrocarbon vapor; d) continuously recovering oil, water, hydrocarbon vapor and non-condensable synthesis gas, the non-condensable synthesis gas being used as heat source for the process; and e) recovering treated waste material from the chamber, the treated waste material having a volume which is about 90% reduced.

In a preferred embodiment of this process, the waste material is a pharmaceutical waste material.

These and other aspects of the invention will be more clearly seen from the detailed description of a preferred embodiment outlined below.

### DESCRIPTION OF THE DRAWING

FIG. 1 is a thermal process flow diagram which illustrates the process according to the invention.

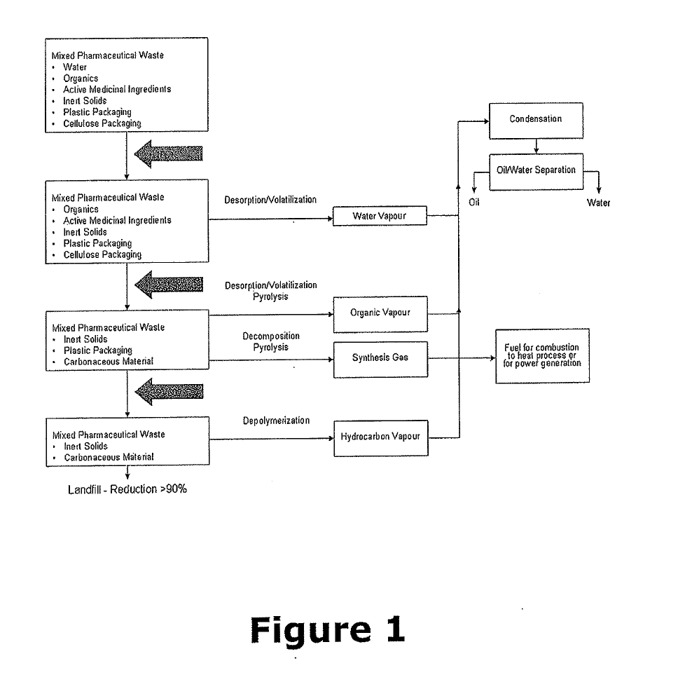

While the invention will be described in conjuncture with the illustrated embodiment, it will be understood that it is not intended to limit the invention to such embodiment. On the contrary, it is intended to cover all alternatives, modifications and equivalents as may be included within the spirit and scope of the invention as defined by the appended claims.

### DETAILED DESCRIPTION OF PREFERRED EMBODIMENTS OF THE INVENTION

As used herein and in the claims, the following terms have the meaning and definition set out below.

The term “pyrolysis” is meant to encompass processes wherein the atmosphere in the pyrolysis chamber may contain a small amount of air (oxygen), but the amount is so small that there is no visible combustion. Although the term “pyrolysis” is generally defined as the “transformation of a compound into one or more substances by heat alone, i.e., without oxidation” (Hawley's Condensed Chemical Dictionary, 13^{th} Ed. (1997).), it is envisaged that at least a small amount of oxygen may be present into the chamber during the process according to the invention. Indeed, some air may enter the chamber during the loading of the waste. Also some air may be entrained within the waste. Moreover, as the pressure within the chamber may be slightly negative, a small amount of air may be drawn into the furnace through deficient seals for example.

The term “waste material” is meant to refer to any suitable product that can be subjected to the process according to the invention, including but not limited to pharmaceutical waste materials. Other streams for which the process according to the invention is also suitable include but are not limited to petrochemical, sludges, packaging, plastics manufacturing, mining, petroleum refining, paint and ink manufacturing as well as mixtures thereof. The waste material can also be a cellulose-based material, polyolefin-based resin, used tires or other industrial rubbers, contaminated soils or mixtures thereof.

The term “non-condensable gas” is meant to refer to a gas which is not readily condensed, and includes gases such as methane, propane or butane but also hydrogen, carbon dioxide and carbon monoxide.

The term “depolymerization” is meant to refer to the process of converting a long chain hydrocarbon-based polymer into a shorter chain hydrocarbon through a sequence of reactions at certain temperatures.

An embodiment of the process according to the invention will be described with reference to the accompanying process flow diagram. The process is carried out in a standard apparatus known in the art.

The waste material to be treated is fed to the reactor hopper. A series of two dual flapper valves or rotary valves are provided at the base of the hopper, each valve feeding the reaction chamber where the thermal process including desorption, depolymerization and pyrolysis, takes place. The use of dual flapper valves or rotary valves limits the ingress of oxygen into the chamber. The waste material is introduced into the reaction chamber at a specific rate which is determined by the valve rate.

In order to facilitate handing and also to have a consistent feedstock, the waste material is shredded prior to being fed to the reactor hopper. During this stage there is some degree of decomposition of the medicinal ingredients through physical breakdown from the shredding action. Preferably, shreds having a dimension of less than about 30 mm are formed. Shredding can be carried out on-site or at another location.

The waste material is placed into an indirectly heated thermal reaction chamber. The reaction chamber is heated externally with hot oil, electrical resistance heating, induction heating, or flue gas from the combustion of fuel. The temperature inside the extraction chamber is controlled by a simple thermal control loop. The pressure in the reaction chamber can be either positive or negative. Preferably, the pressure inside the reaction chamber is negative. An inert gas such as nitrogen or argon can be injected into the chamber such that the process takes place in an inert atmosphere.

The waste material enters the reaction chamber where it is conveyed along the length of a steel reaction tube associated with the reaction chamber, by sloping the said tube. A rotating tube or an auger located inside the reaction chamber continually agitates the material. Heat is transmitted to the waste material inside the reaction chamber via conductive transfer of energy.

Turning to the process flow diagram, at a first stage where the temperature inside the reactor chamber is maintained at about 100° C., water in the waste material is desorbed as water vapor, which can be removed and condensed.

At a second stage, the temperature is increased to about 250 to 350° C., any remaining water from the waste material is desorbed. Also, active organic ingredients are desorbed then decomposed yielding condensable organic vapor and non-condensable synthesis gas. At this stage the condensable organic vapor which may also include some water vapor, is removed and condensed. And the non-condensable synthesis gas is also removed.

A further stepped increase in temperature from 350° C. to about 500° C. in the reaction chamber beyond desorption, volatilization and decomposition temperatures results in depolymerization of plastic resins and polymers. This depolymerization results in the release of condensable hydrocarbons from their solid state allowing for their recovery and reuse. At this stage, any organic ingredients that were not decomposed in the second stage, are decomposed producing hydrocarbon vapor that can be removed through the same means as the organic vapor. At these temperatures the medicinal ingredients resident in the pharmaceutical waste product is thermally decomposed. This decomposition is confirmed via the review of boiling points and decomposition temperatures of medicinal compounds. Several common examples are: acetylsalicylic acid (140° C.), celebrex (150° C.), acetaminophen (170° C.), pseudoephdrine hydrochloride (186° C.), minoxidil (78° C.) and metoropol (120° C.).

Indeed, water vapor, organic vapor and hydrocarbon vapors can be removed together and condensed as a mixture of oil-water. And the mixture of oil and water can further be subjected to a separation step to yield oil and water. The non-condensable synthesis gas can be used as heating source for the process.

The vapors and gases in the reaction chamber are removed either under pressure or by vacuum. The vapors and gases are preferably removed under vacuum. The vapors can be condensed into a liquid using a heat exchanger, quenched with water or with any suitable type of oil fraction similar to diesel. In the case where a recirculating water quench system is used, the condensed oil and water from the process can be separated in an oil water separator and the water fraction is cooled with a heat exchanger and recycled to the quench. In the case where a recirculating oil quench is used, the quenched oil and water can be separated in an oil water separator and the oil fraction is cooled with a heat exchanger and recycled to the quench. In any of these cases, excess oil and water is continuously removed from the process approximately proportional to the mixed waste feed content.

During the process a volume of condensable vapors and non-condensable gases are generated. The condensable hydrocarbons vapors are recovered in a liquid state as described above. The non-condensable gases include methane, propane, butane as well as hydrogen, carbon dioxide and carbon monoxide. These gases can be filtered for further removal of particulate and fine mist and final polishing using activated carbon. The non-condensable gases are commonly referred to as synthesis gas and can be combusted to generate energy for the process or to generate steam for power generation.

The hydrocarbon extracted is similar in terms of its composition to No. 2 Fuel Oil or Diesel and is suitable for reuse or further fractional distillation. A mass balance of the process generates the following outputs based on the input feed characteristics described above.

A certain fraction of the material remains from the process as an inert carbonaceous mass. This solid residue is removed from the reaction chamber using a rotary paddle airlock into a water based cooling system prior to being discharged.

Table 1 outlines an example of composition of a sample that can be treated according to the process of the invention.

TABLE 1

| Summary Mixed | |
|---|---|
| Pharmaceutical | By wt |
| Plastic Bottles | 35% |
| Medicinal ingredients | 10% |
| Paper (cellulose) | 20% |
| Inert Solids & Foil | 25% |
| Other Liquids | 10% |
| | 100% |

Table 2 outlines an example of relative amounts of the products obtained after treatment by the process of the invention.

TABLE 2

| Total | |
|---|---|
| Byproducts | |
| Oil | 35% |
| Gas | 16% |
| Carbon/Inert | 32% |
| Solids | |
| Water | 17% |
| | 100% |

Thus it is apparent that there has been provided in accordance with the invention a process for the thermal treatment of waste materials, in particular pharmaceutical waste materials. The process combines desorption, depolymerization and pyrolysis; and is simple, environmentally friendly and cost efficient. While the invention has been described in conjunction with the illustrated embodiment, it is evident that many alternatives, modifications and variations will be apparent to those skilled in the art in light of the foregoing description. Accordingly, it is intended to embrace all such alternatives, modifications and variations as fall within the spirit and broad scope of the invention.

What is claimed is:

1. A process for the thermal treatment of waste material in a chamber, the process comprising the steps of:
a) heating the chamber at a first temperature to cause water in the material to desorb as water vapor;
b) heating the chamber at a second temperature higher than the first temperature to cause organic ingredients in the material to desorb and decompose producing condensable organic vapor and non-condensable synthesis gas; and
c) heating the chamber to a third temperature higher than the second temperature to cause polymer-based components of the material to depolymerize and decompose producing condensable hydrocarbon vapor.

2. A process as defined in claim 1, wherein the water vapor, the condensable organic vapor and the condensable hydrocarbon vapor are continuously recovered and condensed as an oil-water mixture.

3. A process as defined in claim 1, wherein the non-condensable synthesis gas is continuously recovered as fuel for combustion or for heating.

4. A process as defined in claim 1, wherein the first temperature is about 100° C., the second temperature is about 250 to 350° C. and the third temperature is about 350 to 500° C.

5. A process as defined in claim 1, wherein the waste material is derived from industrial wastes selected from pharmaceutical, petrochemical, packaging, plastics manufacturing, mining, petroleum refining, paint and ink manufacturing, sludges and mixtures thereof; or the waste material is a cellulose material, a polyolefin-based resin, used tires, contaminated soils or mixtures thereof.

6. A process as defined in claim 1, wherein the waste material is a pharmaceutical waste material.

7. A process as defined in claim 1, wherein the waste material is subjected to a size reduction step prior to being placed into the chamber.

8. A process as defined in claim 3, wherein the non-condensable synthesis gas is used as heat source for the process.

9. A process as defined in claim 2 further comprising separating oil and water from the oil-water mixture.

10. A process as defined in claim 7, wherein the size reduction step comprises shredding the waste material to obtain particles having a size of less than about 30 mm.

11. A process as defined in claim 1, wherein heat is transmitted to the chamber through its external surface, the heat stemming from a heating source selected from hot oil, electrical resistance heating, induction heating and flue of the non-condensable synthesis gas.

12. A process according to claim 1, wherein the material in the chamber is subjected to continuous agitation.

13. A process as defined in claim 1, wherein the pressure inside the chamber is negative.

14. A process as defined in claim 1, wherein the atmosphere inside the chamber is substantially free of oxygen.

15. A process as defined in claim 1, wherein the atmosphere inside the chamber is an inert atmosphere.

16. A process as defined in claim 1, wherein an inert gas is introduced into the chamber, the inert gas being nitrogen or argon.

17. A process as defined in claim 1 further comprising recovering treated waste material from the chamber, the treated waste material having a volume which is about 90% reduced.

18. A process for the thermal treatment of waste material in a chamber, the process comprising the steps of:
a) heating the chamber at a first temperature to cause water in the material to desorb as water vapor;
b) heating the chamber at a second temperature higher than the first temperature to cause organic ingredients in the material to desorb and decompose producing condensable organic vapor and non-condensable synthesis gas;
c) heating the chamber to a third temperature higher than the second temperature to cause polymer-based components of the material to depolymerize and decompose producing condensable hydrocarbon vapor;
d) continuously recovering oil, water, hydrocarbon vapor and non-condensable synthesis gas, the non-condensable synthesis gas being used as heat source for the process; and
e) recovering treated waste material from the chamber, the treated waste material having a volume which is about 90% reduced.

19. A process as defined in claim 18, wherein the first temperature is about 100° C., the second temperature is about 250 to 350° C. and the third temperature is about 350 to 500° C.

20. A process as defined in claim 18, wherein the waste material is a pharmaceutical waste material.

21. A process as defined in claim 18, wherein the waste material is subjected to a size reduction step prior to being placed into the chamber.

22. A process as defined in claim 18, wherein heat is transmitted to the chamber through its external surface, the heat stemming from a heating source selected from hot oil, electrical resistance heating, induction heating and flue of the non-condensable synthesis gas.

23. A process as defined in claim 18, wherein the atmosphere inside the chamber is an inert atmosphere.

24. A process as defined in claim 18, wherein the pressure inside the chamber is negative.
